(19) United States
(12) Patent Application Publication
(10) Pub. No.: US 2019/0058515 A1
(43) Pub. Date: Feb. 21, 2019

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Yu Jiang, Beijing (CN); Liu Liu, Beijing (CN); Huiling Jiang, Beijing (CN)

(73) Assignee: NTT DOCOMO, INC., Tokyo (JP)

(21) Appl. No.: 15/761,562

(22) PCT Filed: Sep. 9, 2016
(86) PCT No.: PCT/JP2016/076601

§ 371 Date: Mar. 20, 2018

(30) Foreign Application Priority Data
Sep. 24, 2015 (JP) 2015-187473

(51) Int. Cl. H04B 7/06; H04J 11/00; H04W 24/10; H04W 16/14; H04L 5/00

(52) U.S. Cl. CPC H04B 7/0626; H04J 11/0069; H04L 5/0048; H04W 16/14; H04W 24/10

(57) ABSTRACT

The present disclosure is designed to carry out cell search and/or Radio Resource Management (RRM) measurements accurately even in carriers in which Listen Before Talk (LBT) is configured. According one example of the present disclosure, a user terminal communicates by using a cell in which listening is executed before signal are transmitted, and has a receiving section that receives a detection/measurement signal including a first synchronization signal and a second synchronization signal, and a measurement section that carries out measurements by using a channel state measurement reference signal, which is included in the detection/measurement signal, and which is frequency-multiplexed with the first synchronization signal and/or the second synchronization signal.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, the specifications of LTE-A (also referred to as LTE-advanced, LTE Rel. 10, 11 or 12) have been drafted for further broadbandization and increased speed beyond LTE (also referred to as LTE Rel. 8 or 9), and successor systems of LTE (also referred to as, for example, FRA (Future Radio Access), 5G (5th generation mobile communication system), LTE Rel. 13 and so on) are under study.

The specifications of Rel. 8 to 12 LTE have been drafted assuming exclusive operations in frequency bands that are licensed to operators—that is, licensed bands. As licensed bands, for example, 800 MHz, 2 GHz, 1.7 GHz and 2 GHz are used.

In recent years, user traffic has been increasing steeply following the spread of high-performance user terminals (UE: User Equipment) such as smart-phones and tablets. Although more frequency bands need to be added to meet this increasing user traffic, licensed bands have limited spectra (licensed spectra).

Consequently, a study is in progress with Rel. 13 LTE to enhance the frequencies of LTE systems by using bands of unlicensed spectra (also referred to as “unlicensed bands”) that are available for use apart from licensed bands (see non-patent literature 2). For unlicensed bands, for example, the 2.4 GHz band and the 5 GHz band, where Wi-Fi (registered trademark) and Bluetooth (registered trademark) can be used, are under study for use.

To be more specific, with Rel. 13 LTE, a study is in progress to execute carrier aggregation (CA) between licensed bands and unlicensed bands. Communication that is carried out by using unlicensed bands with licensed bands like this is referred to as “LAA” (License-Assisted Access). Note that, in the future, dual connectivity (DC) between licensed bands and unlicensed bands and stand-alone in unlicensed bands may become the subject of study under LAA.

For unlicensed bands in which LAA is run, a study is in progress to introduce interference control functionality in order to allow co-presence with other operators' LTE, Wi-Fi or different systems. In Wi-Fi, LBT (Listen Before Talk), which is based on CCA (Clear Channel Assessment), is used as an interference control function within the same frequency. LBT refers to the technique of “listening” (sensing) before transmitting signals, and controlling transmission based on the result of listening. In Japan and Europe, the LBT function is stipulated as mandatory in systems such as

### CITATION LIST

### Non-Patent Literature

Non-Patent Literature 1: 3GPP TS 36. 300 “Evolved Universal Terrestrial Radio Access (E-UTRA) and Evolved Universal Terrestrial Radio Access Network (E-UTRAN); Overall Description; Stage 2”

Non-Patent Literature 2: AT&T, Drivers, Benefits and Challenges for LTE in Unlicensed Spectrum, 3GPP TSG-RAN Meeting #62 RP-131701

### SUMMARY OF INVENTION

### Technical Problem

Now, a study is in progress to transmit, in unlicensed band cells, signals for use by UEs for RRM (Radio Resource Management) measurements and so on (referred to as, for example, the “discovery signal” (DS).

When an existing DS is used, if the length of the DS is configured short, the volume of resources that can be placed in the DS, such as synchronization signals, reference signals and so on becomes smaller. Moreover, when an existing DS is used, if the length of the DS is configured long, symbols that do not include signals may be created in the DS, and this raises the possibility that another system (for example, Wi-Fi) might succeed in LBT during the period the DS is transmitted. In this case, this system starts transmitting signals, and these signals will contend with the DS. Either case faces the threat that it is difficult to conduct the cell search and/or RRM measurements in LAA accurately, and communication cannot be carried out adequately.

The present invention has been made in view of the above, and it is therefore an object of the present invention to provide a user terminal, a radio base station and a radio communication method, whereby cell search and/or RRM measurements can be carried out accurately even in carriers (for example, unlicensed bands) in which LBT (pre-transmission listening) is executed.

### Solution to Problem

According to one example of the present invention, a user terminal communicates by using a cell in which listening is executed before signal are transmitted, and has a receiving section that receives a detection/measurement signal including a first synchronization signal and a second synchronization signal, and a measurement section that carries out measurements by using a channel state measurement reference signal, which is included in the detection/measurement signal, and which is frequency-multiplexed with the first synchronization signal and/or the second synchronization signal.

### Advantageous Effects of Invention

According to the present invention, cell search and/or RRM measurements can be carried out accurately even in carriers in which LBT is executed.

### BRIEF DESCRIPTION OF DRAWINGS

FIG. 1A is a diagram to show an example of a radio resource configuration of an existing LAA DRS, and FIG. 1B is a diagram to show another example of a radio resource configuration of an existing LAA DRS;

FIG. 2 is a diagram to show an example of a radio resource configuration of an LAA DRS according to embodiment 1.1;

FIG. 3 is a diagram to show an example of a radio resource configuration of an LAA DRS according to embodiment 1.2;

FIG. 4 is a diagram to show an example of a radio resource configuration of an LAA DRS according to embodiment 1.3;

FIG. 5 is a diagram to show an example of a radio resource configuration of an LAA DRS according to a second embodiment;

FIG. 6A is a diagram to show an example of a radio resource configuration of an LAA DRS according to a third embodiment, and FIG. 6B is a diagram to show another example of a radio resource configuration of an LAA DRS according to the third embodiment;

FIG. 7 is a diagram to show an example of a schematic structure of a radio communication system according to an embodiment of the present invention;

FIG. 8 is a diagram to show an example of an overall structure of a radio base station according to an embodiment of the present invention;

FIG. 9 is a diagram to show an example of a functional structure of a radio base station according to an embodiment of the present invention;

FIG. 10 is a diagram to show an example of an overall structure of a user terminal according to an embodiment of the present invention; and

FIG. 11 is a diagram to show an example of a functional structure of a user terminal according to an embodiment of the present invention.

### DESCRIPTION OF EMBODIMENTS

In systems (for example, LAA systems) that run LTE/LTE-A in unlicensed bands, interference control functionality is likely to be necessary in order to allow co-presence with other operators' LTE, Wi-Fi, or other different systems. Note that, systems that run LTE/LTE-A in unlicensed bands may be collectively referred to as “LAA,” “LAA-LTE,” “LTE-U,” “U-LTE” and so on, regardless of whether the mode of operation is CA, DC or SA.

Generally speaking, when a transmission point (for example, a radio base station (eNB), a user terminal (UE) and so on) that communicates by using a carrier (which may also be referred to as a “carrier frequency,” or simply a “frequency”) of an unlicensed band detects another entity (for example, another UE) that is communicating in this unlicensed band carrier, the transmission point is disallowed to make transmission in this carrier.

So, the transmission point executes listening (LBT) at a timing that is a predetermined period ahead of transmission timing. To be more specific, by executing LBT, the transmission point searches the whole of the target carrier band (for example, one component carrier (CC)) at a timing that is a predetermined period ahead of a transmission timing, and checks whether or not other devices (for example, radio base stations, UEs, Wi-Fi devices and so on) are communicating in this carrier band.

Note that, in the present description, “listening” refers to the operation which a given transmission point (for example, a radio base station, a user terminal, etc.) performs before transmitting signals in order to check whether or not signals to exceed a predetermined level (for example, predetermined power) are being transmitted from other transmission points. Also, this “listening” performed by radio base stations and/or user terminals may be referred to as “LBT,” “CCA,” “carrier sensing” and so on.

If it is confirmed that no other devices are communicating, the transmission point carries out transmission using this carrier. If the received power measured during LBT (the received signal power during the

LBT period) is equal to or lower than a predetermined threshold, the transmission point judges that the channel is in the idle state (LBT) and carries out transmission. When a “channel is in the idle state,” this means that, in other words, the channel is not occupied by a specific system, and it is equally possible to say that a channel is “idle,” a channel is “clear,” a channel is “free,” and so on.

On the other hand, if only just a portion of the target carrier band is detected to be used by another device, the transmission point stops its transmission. For example, if the transmission point detects that the received power of a signal from another device entering this band exceeds a predetermined threshold, the transmission point judges that the channel is in the busy state (LBT_{busy}), and makes no transmission. In the event LBT_{busy} is yielded, LBT is carried out again with respect to this channel, and the channel becomes available for use only after it is confirmed that the channel is in the idle state. Note that the method of judging whether a channel is in the idle state/busy state based on LBT is by no means limited to this.

As LBT mechanisms (schemes), FBE (Frame Based Equipment) and LBE (Load Based Equipment) are currently under study. Differences between these include the frame configurations to use for transmission/receipt, the channel-occupying time, and so on. In FBE, the LBT-related transmitting/receiving configurations have fixed timings. Also, in LBE, the LBT-related transmitting/receiving configurations are not fixed in the time direction, and LBT is carried out on an as-needed basis.

To be more specific, FBE has a fixed frame cycle, and is a mechanism of carrying out transmission if the result of executing carrier sensing for a certain period (which may be referred to as “LBT duration” and so on) in a predetermined frame shows that a channel is available for use, and not making transmission but waiting until the next carrier sensing timing if no channel is available.

On the other hand, LBE refers to a mechanism for implementing the ECCA (Extended CCA) procedure of extending the duration of carrier sensing when the result of carrier sensing (initial CCA) shows that no channel is available for use, and continuing executing carrier sensing until a channel is available. In LBE, random backoff is required to adequately avoid contention.

Note that the duration of carrier sensing (also referred to as the “carrier sensing period”) refers to the time (for example, the duration of one symbol) it takes to gain one LBT result by performing listening and/or other processes and deciding whether or not a channel can be used.

A transmission point can transmit a predetermined signal (for example, a channel reservation signal) based on the result of LBT. Here, the result of LBT refers to information about the state of channel availability (for example, “LBT_{idle},” “LBT_{busy},” etc.), which is acquired by LBT in carriers where LBT is configured.

As described above, by introducing interference control for use within the same frequency that is based on LBT mechanisms to transmission points in LAA systems, it is possible to prevent interference between LAA and Wi-Fi, interference between LAA systems and so on. Furthermore, even when transmission points are controlled independently per operator that runs an LAA system, it is possible to reduce interference without learning the details of each operator's control, by means of LBT.

Now, in LAA systems, to configure and/or reconfigure unlicensed band SCells (Secondary Cells) in UEs, a UE has to detect SCells that are present in the surroundings by means of RRM (Radio Resource Management) measurements, measure their received quality, and then send a report to the network. The signal to allow RRM measurements in LAA is under study based on the discovery reference signal (DRS) that is stipulated in Rel. 12.

Note that the signal for RRM measurements in LAA may be referred to as the “detection/measurement signal,” the “discovery reference signal” (DRS), the “discovery signal” (DS), the “LAA DRS,” the “LAA DS” and so on. Also, an unlicensed band SCell may be referred to as, for example, an LAA SCell.

Similar to Rel. 12 DS, the LAA DRS may be constituted by a combination of synchronization signals (PSS (Primary Synchronization Signal)/SSS (Secondary Synchronization Signal)) and a cell-specific reference signal (CRS) of existing systems (for example, LTE Rel. 10 to 12), a combination of synchronization signals (PSS/SSS), the CRS and the channel state information reference signal (CSI-RS) of existing systems, and so on.

Also, the network (for example, eNBs) can configure the DMTC (Discovery Measurement Timing Configuration) of the LAA DRS in UEs per frequency. The DMTC contains information about the transmission cycle of the DRS (which may be also referred to as “DMTC periodicity” and so on), the offset of DRS measurement timings, and so on.

The DRS is transmitted per DMTC periodicity, in the DMTC duration. Here, according to Rel. 12, the DMTC duration is fixed to 6 ms. Also, the length of the DRS (which may be also referred to as the “DRS occasion,” the DS occasion,” the “DRS burst,” the “DS burst” and so on) that is transmitted in the DMTC duration is between 1 ms and 5 ms. Although studies are in progress to apply the same configurations to LAA, the DRS occasion does not necessarily have to be 1 ms or longer, and can be 1 ms or shorter. From the perspective of finishing measurements in short time, it is preferable to make the DRS occasion 1 ms or shorter.

An eNB executes LBT before transmitting an LAA DRS, and transmits the LAA DRS if LBT_{idle} is yielded. A UE learns the timing and the cycle of the LAA DRS measurement period based on the DMTC reported from the network, and executes LAA DRS measurements. Note that a study is in progress to support a plurality of transmission candidate locations in a DMTC duration when an LAA DRS alone is transmitted. For example, even when a predetermined cell fails to transmit a DRS in the first candidate location due to LBT_{busy}, there is still a possibility that the DRS can be transmitted in another candidate location within the same DMTC periodicity.

LAA DRSs are preferably continuous in time so as to prevent other systems that succeed in LB T from interrupting. Moreover, it is preferable if cell detection and measurements can be carried out based on a single DRS. Various DRS designs are proposed for the purpose of meeting these demands.

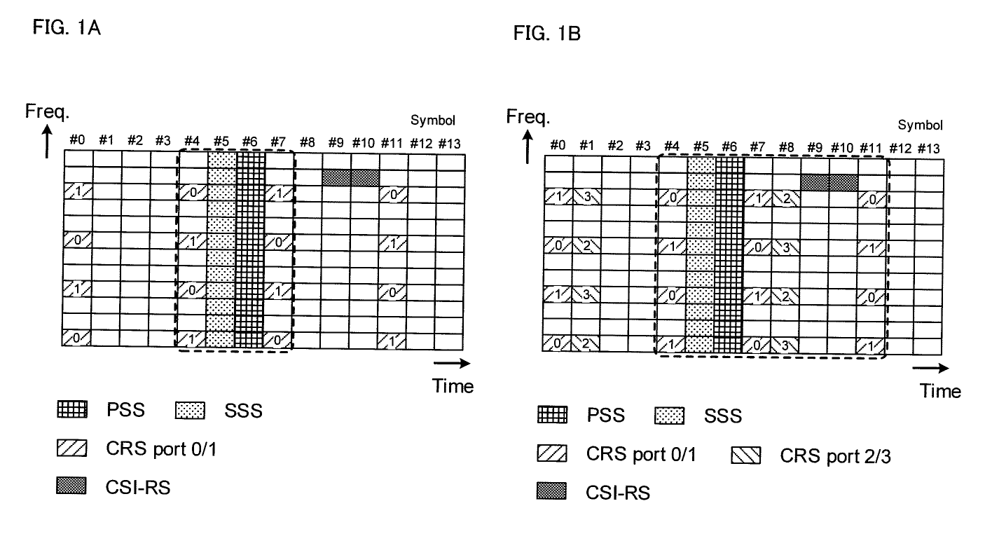

FIGS. 1 provide diagrams, each showing an example of a radio resource configuration of an existing LAA DRS. FIG. 1A shows a configuration, which places a significance on temporal continuity, and which therefore makes the length of the DRS short—4 symbols. The configuration of FIG. 1A is equivalent to a configuration in which the portion of continuous symbols (#4 to #7) is cut out from the Rel. 12 DRS, and includes CRSs (ports 0/1), a PSS and an SSS. However, this configuration has no CSI-RS field, and cells (or transmission points (TPs) that use CSI-RSs cannot be recognized. Note that, a “CRS port X” refers to a CRS that is transmitted by an antenna port X.

FIG. 1B shows a configuration, which places a significance on the accuracy of detection/measurements, and which therefore makes the length of the DRS long—8 symbols. The configuration of FIG. 1B is equivalent to a configuration in which, in addition to the portion of continuous symbols in the Rel. 12 DRS (#4 to #7), the CRSs (port 2/3) of symbol #8, the CSI-RSs of symbols #9 and #10 and the CRSs (port 0/1) of symbol #11 are included. However, if no CSI-RS is configured, this DRS has no temporal continuity.

Besides this, other DRS resource configurations are also under study, but these configurations, too, have various problems that are unsolved, such as that these configurations change the configuration of the existing Rel. 12 DRS too much and therefore are not feasible for implementation, these configurations fail to provide temporal continuity depending on the absence/presence and the configuration of CSI-RSs, and so on. That is, there is a demand for a DRS configuration that can be used effectively in order to carry out cell search and/or RRM measurements accurately in LAA.

So, the present inventors have come up with the idea of mapping CSI-RSs, in the DRS (LAA DRS) that is transmitted in a carrier in which LBT is configured, even when the length of the DRS is short. Moreover, the present inventors have come up with a DRS configuration that provides temporal continuity, even when the length of the DRS is long, without relying on CSI-RSs.

Now, embodiments of the present invention will be described in detail below with reference to the accompanying drawings. Although examples will be described with each embodiment below where CA is executed assuming that the PCell is a licensed band and an SCell is an unlicensed band, this is by no means limiting.

That is, embodiments of the present invention can be configured so that a structure to make a licensed band (and the PCell) a carrier where listening (LBT) is not configured (which may also be referred to as a carrier that does execute LBT, a carrier that cannot execute LBT, and so on), and make an unlicensed band (and an SCell) a carrier where listening (LBT) is configured (which may also be referred to as a carrier that executes LBT, a carrier that should execute LBT, and so on) can be used in each embodiment.

Also, the combination of carriers where LBT is not configured and carriers where LBT is configured, and PCells and SCells are not limited to that given above. For example, the present invention is applicable to the case where a UE connects with an unlicensed band (a carrier where listening (LBT) is configured) in stand-alone.

(Radio Communication Method)

### First Embodiment

The first embodiment of the present invention forms the DRS by using four consecutive symbols. This DRS configuration includes at least a PSS, an SSS, a CRS (for example, CRS port 0/1) and a CSI-RS. In the following description, a configuration in which the PSS/SSS are included over six resource blocks (also referred to as “RBs” (Resource Blocks), “PRBs” (Physical Resource Blocks) and so on) (embodiment 1.1), a configuration in which the PSS/SSS are repeated in the frequency direction and included (embodiment 1.2), a configuration which provides a plurality of candidate DRS transmission locations in one subframe (embodiment 1.3), and a configuration in which rate matching is applied when the DRS and the PDSCH/EPDCCH are multiplexed (embodiment 1.4).

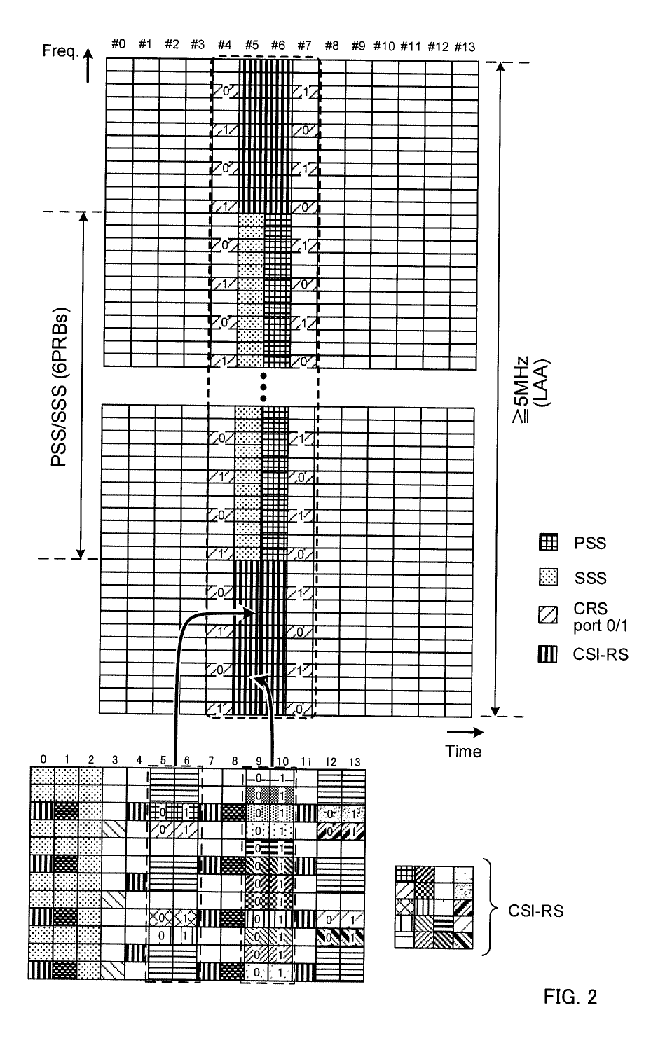

FIG. 2 is a diagram to show an example of a radio resource configuration in a LAA DRS according to embodiment 1.1. In FIG. 2 consecutive symbols #4 to #7 constitute the LAA DRS. To be more specific, CRSs (port 0/1) are mapped to the first and the last symbol (symbols #4 and #7) in the four consecutive symbols, and synchronization signals (the PSS and the SSS) are mapped to the second and the third symbol (symbols #5 and #6) from the beginning of the four consecutive symbols. Note that it is not necessary to transmit a CRS from port 1 (or 0), and, in this case, CRS port 0 (or 1) alone may be mapped.

Furthermore, in symbols #5 and #6, CSI-RSs are mapped to radio resources that are outside (that have higher or lower frequencies than) the PSS/SSS. That is, in symbols #5 and #6, the PSS/SSS are transmitted in the center frequency (six PRBs around the center) of a predetermined carrier in which LBT is configured, and CSI-RSs are transmitted in PRBs in which the PSS/SSS are allocated.

Here, the CSI-RS resource mapping in symbols #5 and #6 may be determined based on existing CSI-RS configurations (CSI-RS RE (Resource Element) configurations). For example, an existing CSI-RS configuration in one PRB that is for use when there are two antenna ports is shown in the bottom part of FIG. 2. In existing LTE systems, 8 REs of symbols #5 and #6, 24 REs of symbols #9 and #10 and 8 REs of symbol #12 and #13 are resources where CSI-RSs can be mapped, and in which REs CSI-RS are mapped is determined based on the configuration of CSI-RSs.

For example, referring to FIG. 2, the CSI-RSs outside the PSS/SSS may be mapped by using the resources of symbols #5 and #6 in each RB where an existing CSI-RS configuration is present. In this case, 8 REs can be used for CSI-RSs in each RB, so that a UE can recognize maximum four TPs based on the CSI-RSs.

Also, referring to FIG. 2, the CSI-RSs outside the PSS/SSS may be mapped by using the resources of symbols #9 and #10 in each RB where an existing CSI-RS configuration is present. That is, the CSI-RSs can be mapped to any of all the REs of symbols #5 and #6. In this case, in each RB, 24 REs can be used for CSI-RSs, so that a UE can recognize maximum 12 TPs based on the CSI-RSs.

Note that the configuration of CSI-RSs that are arranged in the same symbols with the PSS/SSS may be referred to as, for example, an “extended CSI-RS configuration.” A UE may execute detection/measurement processes that use the CSI-RSs included in the DRS based on information about the extended CSI-RS configuration. The information about the extended CSI-RS configuration may be reported to the UE by using one or a combination of higher layer signaling (for example, RRC (Radio Resource Control) signaling, broadcast information (MIBs, SIBs, etc.)) and downlink control information (DCI).

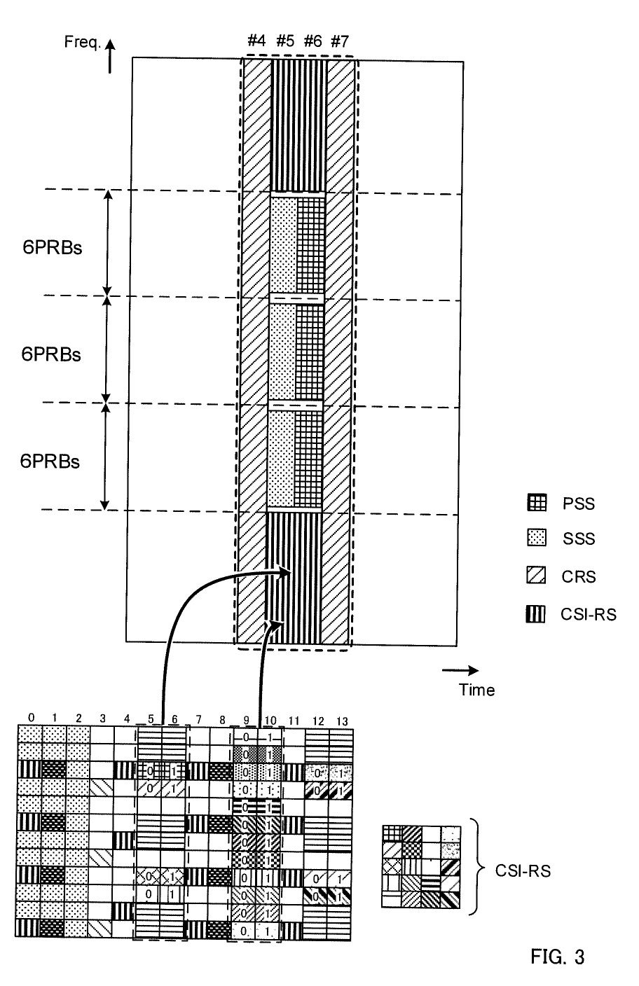

FIG. 3 is a diagram to show an example of a radio resource configuration in an LAA DRS according to embodiment 1.2. In FIG. 3, consecutive symbols #4 to #7 constitute the LAA DRS. To be more specific, as in the existing Rel. 12 DRS, CRSs are mapped to symbols #4 and #7, and synchronization signals (PSSs and SSSs) are mapped to symbols #5 and #6. Note that the CRSs may be transmitted from antenna ports other than port 0/1, or may be mapped in the same way as in embodiment 1.1.

Referring to symbols #5 and #6 of FIG. 3, the PSSs/SSSs, each allocated to 6 PRBs, are repeated in the frequency direction and included. To be more specific—that is, in symbols #5 and #6—three PSSs/SSSs are transmitted by using a total of 18 PRBs of frequency resources, including 6 PRBs including the center frequency (six PRBs around the center) of a predetermined carrier in which LBT is configured, and six PRBs on either side of this, and, in outside radio resources where the PSSs and SSSs are not allocated (where the frequency is higher or lower), CSI-RSs are allocated.

Note that the PSS/SSS sequence in the center and the neighboring PSS/SSS sequences may be the same, or may be different. Moreover, the resource locations and/or the resource mapping of the CSI-RSs may be determined based on the same rules as in embodiment 1.1.

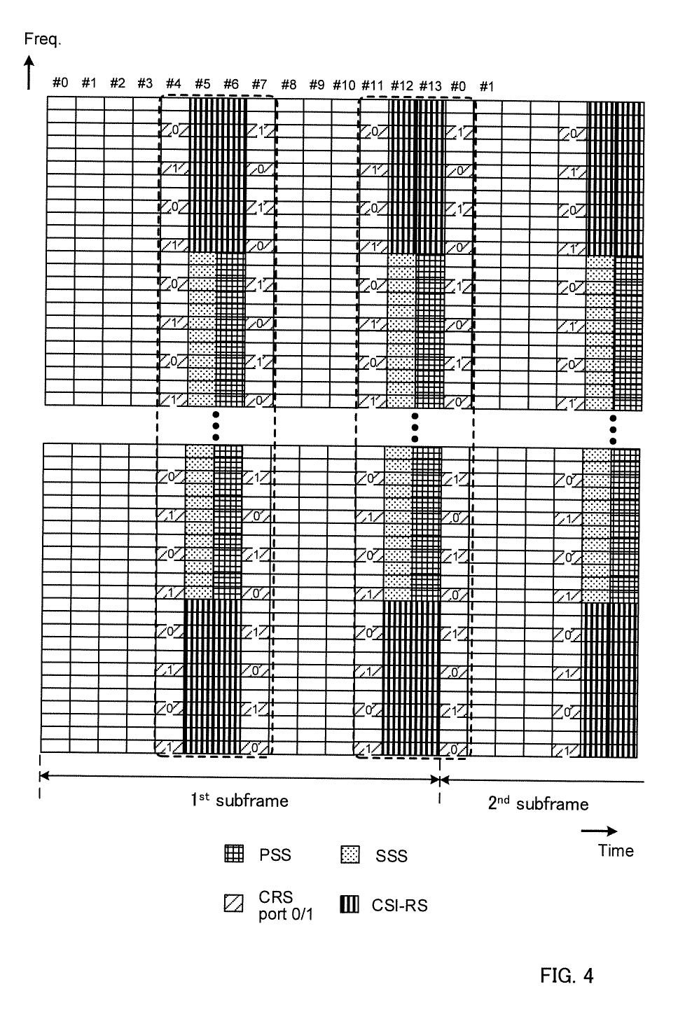

FIG. 4 is a diagram to show an example of a radio resource configuration in an LAA DRS according to embodiment 1.3. Embodiment 1.3 is equivalent to an extended version of the DRS radio resource configuration of embodiment 1.1 and/or embodiment 1.2, a plurality of (for example, two, three or more) DRS locations (candidate DRS locations, which may also be referred to simply as candidate locations) are provided in a DRS occasion (for example, in one subframe).

For example, in embodiment 1.3, one set of consecutive symbols constitute one candidate DRS, another set of consecutive symbols constitutes another candidate DRS. Note that the consecutive symbols here may stretch over a plurality of subframes. In FIG. 4, consecutive symbols #4 to #7 in a predetermined subframe constitute one DRS (the first DRS), and consecutive symbols #11 to #13 and symbol #0 of the next subframe constitute another DRS (a second DRS).

The resource location and/or the resource mapping of each signal in each DRS location may be determined based on the same rules as in embodiment 1.1 and/or embodiment 1.2. For example, in the example of FIG. 4, the resource mapping in the first DRS location is the same as in embodiment 1.1, and the resource mapping in the second DRS location shifts the mapping of the first DRS location by 7 symbols.

To be more specific, in FIG. 4, a UE may support candidate locations for placing a PSS/SSS/CSI-RSs in symbols #5 and #6 and placing CRSs in symbols #4 and #7, and candidate locations for placing a PSS/SSS/CSI-RSs in symbols #12 and #13 and placing CRSs in symbol #11 and in symbol #0 of the next subframe.

Note that the PSS/SSS at the center in embodiment 1.1, the PSS/SSS sequences at the center and the neighboring PSSs/SSSs in embodiment 1.2 and so on may be used to specify the DRS location in the same subframe. For example, the PSS and/or SSS sequences included in a DRS may be associated with candidate DRS locations where the DRS may be transmitted.

The PSS/SSS sequences included in the first DRS location and the PSS/SSS sequences included in the second DRS location may be configured differently. To be more specific, the existing SSS sequence for subframe #0 in the radio frame and the existing SSS sequence for subframe #5 may be used in respective DRS locations (candidate locations).

Moreover, when a DRS location that is comprised of symbols of a plurality of subframes is mapped to the last subframe in DMTC, the CRSs that are included in the subsequent subframe are not included. For example, when the second DRS location in FIG. 4 is mapped to the last subframe in DMTC, the CRSs in symbol #0 of the next subframe need not be included (that is, can be removed).

In embodiment 1.4, rate matching is applied when the PDSCH/EPDCCH and the DRS are multiplexed. Here, a UE can perform the rate matching process based on at least one of the following assumptions.

The UE may assume that, in a DRS, the PDSCH/EPDCCH are not mapped to the REs where the PSS/SSS are allocated. Moreover, when CSI-RSs are configured in a DRS, the UE may assume that the PDSCH/EPDCCH are not mapped to the REs where the CSI-RSs are allocated, in the DRS.

Also, when a plurality of DRS locations are provided (configured), the UE may assume that the PDSCH/EPDCCH are mapped to fixed DRS locations in a subframe (the PDSCH/EPDCCH are not mapped to predetermined DRS locations in a subframe). For example, the UE may assume that a DRS is mapped to symbols #4 to #7.

As described above, according to the first embodiment, the length of the DRS is made short and CSI-RSs are mapped, thereby enabling TP detection. In addition, by providing a plurality of candidate DRS transmission locations in a subframe, it is possible to increase the rate of DRS transmission, and improve the possibility that a UE performs cell detection and/or measurements by using DRSs.

### Second Embodiment

According to a second embodiment of the present invention, the DRS is configured by using a relatively long DRS length. This DRS configuration includes at least a PSS, an SSS, CRSs (for example, CRS port 0/1) and CSI-RSs.

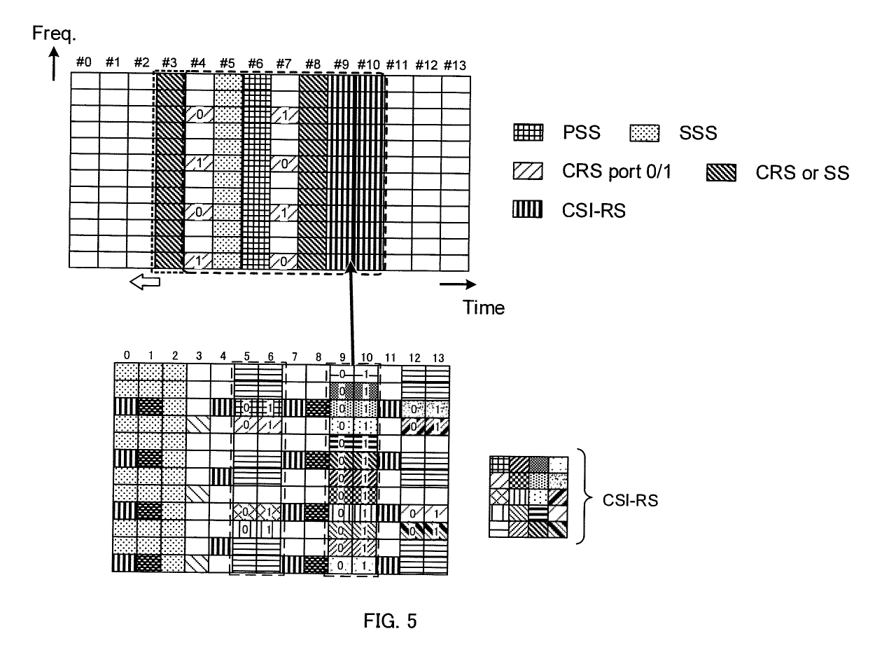

FIG. 5 is a diagram to show an example of a radio resource configuration in an LAA DRS according to the second embodiment. In FIG. 5, an LAA DRS is configured to include at least consecutive symbols #4 to #8. To be more specific, CRSs (port 0/1) are mapped to symbols #4 and #7, and synchronization signals (the PSS and the SSS) are mapped to symbols #5 and #6. Note that it is not necessary to transmit a CRS from port 1 (or 0), and, in this case, CRS port 0 (or 1) alone may be mapped.

With the second embodiment, signals (also referred to as “additional signals”) that are not included in existing DRSs (for example, the Rel. 12 DRS) are additionally placed at least in symbol #8. The additional signal may be, for example, synchronization signals (the SSS, the PSS, etc.), CRSs, or a combination of these. By placing CRSs, it is possible to improve the reliability of RSRP (Reference Signal Received Power) measurements, and, by placing synchronization signals, it is possible to improve the rate of cell detection. Note that, for the CRSs, CRS port 0/1 may be used continuously, CRS port 2/3 may be used, or CRSs to correspond to other antenna ports may be used.

Furthermore, the additional signals are not limited to the above signals, and either other reference signals or other control signals (for example, broadcast information (MIB s (Master Information Blocks), SIB s (System Information Blocks) and so on)), or a combination of these, may be used. Note that, when a synchronization signal is used as an additional signal, this synchronization signal may be referred to as, for example, an “eSS” (enhanced SS), an “additional SS,” a “new SS,” an “LAA SS,” an “LAA DRS SS,” an “LAA DS SS,” the “Rel. 13 SS” and so on. Moreover, additional signals may be arranged at 3-RE intervals (for example, in the same frequency resources as those of CRS port 0/1), or may be arranged by using arbitrary frequency resources.

Furthermore, with the second embodiment, when CSI-RSs are configured in a UE, an LAA DRS may be configured to include at least symbols #4 to #10 that are consecutive. In this case, CSI-RSs are mapped to symbols #9 and #10. The CSI-RS resource mapping in symbols #9 and #10 may be determined based on existing CSI-RS configurations. For example, the CSI-RSs of symbols #9 and #10 may be mapped by using the resources of symbols #9 and #10 in existing CSI-RS configurations, or may be mapped by using the resources of symbols #5 and #6 in existing CSI-RS configurations.

Note that, similar to embodiment 1.1, CSI-RS s may be mapped outside the frequency regions of the PSS/SSS (so as to sandwich the frequency regions of the PSS/SSS). Moreover, similar to embodiment 1.2, the PSS/SSS may be repeated in the frequency direction and arranged.

Note that additional signals (symbols) compared to existing DRSs may be arranged in other symbols as well. For example, additional signals may be arranged in symbol #3, or additional signals may be arranged in symbols #3 and #2. Besides, in symbols #1 and in symbols #11, #12 and #13, too, additional signals may be arranged so that symbols are arranged continuously in the DRS. The combination of symbols to place additional signals may be, for example, {#8, #3}, {#8, #3, #2} and so on, but is by no means limited to these.

Note that, when the PDSCH/EPDCCH are multiplexed on a symbol where an additional signal is planned to be arranged, the additional signal needs not be transmitted (the transmission may be cancelled). Moreover, in a subframe in which a DRS is transmitted, CRSs that are not included in the DRSs may be used for RSRP measurements.

With the second embodiment, regardless of whether or not a DRS is multiplexed with the PDSCH/EPDCCH, a UE:

detects the PSS/SSS in candidate DRS locations;

detects CRSs in symbols #4 and #7;

detects CRSs in additional symbols (then, when none is detected, detects CRSs in symbols outside the DRS occasion in the same subframe); and

when CSI-RSs are configured, detects the CSI-RSs.

As described above, according to the second embodiment, by making the length of the DRS long and mapping CSI-RSs, it is possible to detect many TPs. Furthermore, since it is possible to use many CRSs for RSRP measurements in subframes in which DRSs are transmitted, it is possible to achieve the high accuracy of RRM measurements.

### Third Embodiment

According to a third embodiment of the present invention, it is possible to set up DRS configurations (for example, DRS occasions, the DRS signal configuration (pattern) and so on). An eNB may determine DRS configurations to transmit to a predetermined UE (or a plurality of UEs in a cell) based on the received quality, the channel states and/or the condition of interference that are measured, feedback information (for example, CSI) from the UE, information about power, channel quality, channel states and so on that is reported from other eNBs, or a combination these pieces of information, and reports the determined DRS configurations to the UE.

For example, when the ratio of received signals to interference/noise (SINR: Signal-to-Interference plus Noise Ratio) is good, the eNB may decide to use a DRS in which the DRS occasion (the DRS length) is short. In addition, when the SINR is lower than a predetermined threshold, the eNB may decide to use a DRS in which the DRS occasion is relatively long.

A UE can judge, for example, at least one of the DRS occasion and the DRS signal configuration based on information about DRS configurations, and receive the DRS, execute DRS-based detection/measurement processes and so on. Note that the information about DRS configurations may be reported to the UE by using one or a combination of higher layer signaling (for example, RRC (Radio Resource Control) signaling, broadcast information (MIB s, SIBs, etc.)) and downlink control information (DCI).

For example, the information about DRS configurations ma y be information that relates to at least one of the DRS signal configuration, the resource location of each signal in the DRS (for example, the locations of resources (symbols) where additional signals are included, the resource locations of synchronization signals that are transmitted repeatedly in the frequency direction, etc.), the number of synchronization signals, the sequences of synchronization signals, extended CSI-RS configurations, DRS occasions, the DRS length, candidate DRS transmission locations, an indication of whether or not the DRS overlaps a shared channel, and so on. Furthermore, when the corresponding relationships between indices that indicate DRS configurations and DRS configurations are defied or reported in advance, information about DRS configuration may be provided in the form of indices that represent configurations.

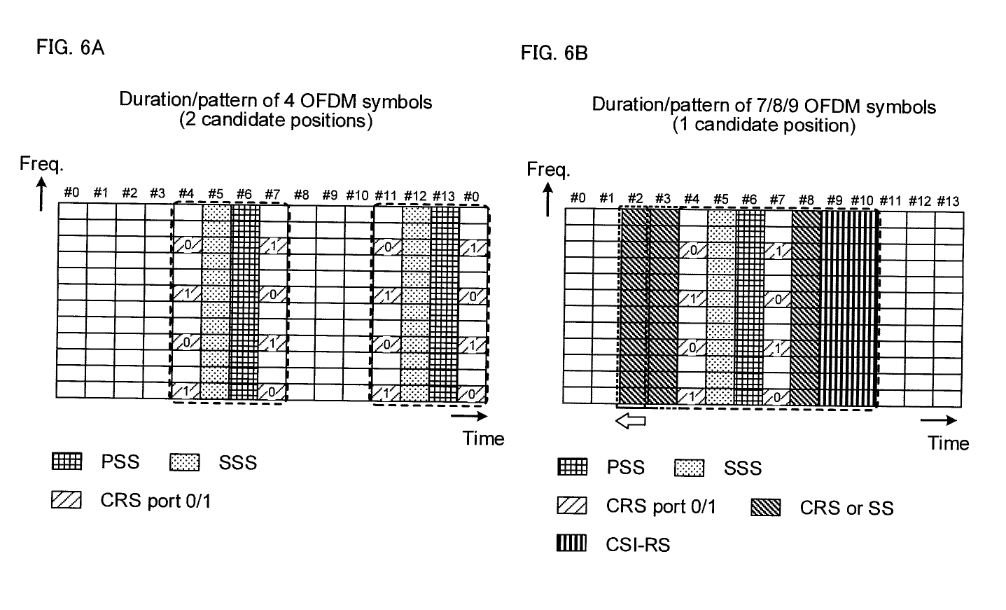

FIG. 6 is a diagram to show an example of a radio resource configuration in an LAA DRS according to the third embodiment. For example, as has been shown with embodiment 1.3, a plurality of candidate locations where a 4-symbol DRS can be allocated (FIG. 6A). Also, it is equally possible to configure one candidate location where a DRS of 7/8/9 symbols can be allocated, by using additional signals, as has been shown with embodiment 2 (FIG. 6B).

As described above, according to the third embodiment, by signaling LAA DRS configurations of on a dynamic basis, it is possible to flexibly change the DRS configurations depending on changes in the communicating environment.

Note that the radio communication methods of the above-described embodiment may be applied individually or may be applied in combination.

(Radio Communication System)

Now, the structure of the radio communication system according to an embodiment of the present invention will be described below. In this radio communication system, the radio communication method according to one and/or a combination of the above-described embodiments of the present invention is employed.

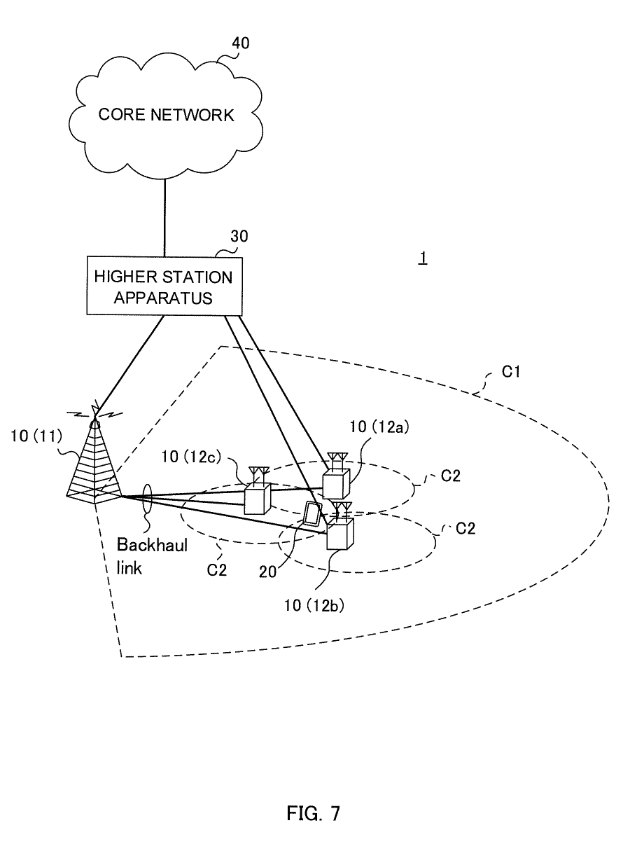

FIG. 7 is a diagram to show an example of a schematic structure of a radio communication system according to an embodiment of the present invention. The radio communication system 1 can adopt carrier aggregation (CA) and/or adopt dual connectivity (DC) to group a plurality of fundamental frequency blocks (component carriers) into one, where the LTE system bandwidth constitutes one unit. Also, the radio communication system 1 has a radio base station (for example, an LTE-U base station) that is capable of using unlicensed bands.

Note that the radio communication system 1 may be referred to as “SUPER 3G,” “LTE-A,” (LTE-Advanced), “IMT-Advanced,” “4G” (4th generation mobile communication system), “5G” (5th generation mobile communication system), “FRA” (Future Radio Access) and so on.

The radio communication system 1 shown in FIG. 7 includes a radio base station 11 that forms a macro cell C1, and radio base stations 12 (12a to 12c) that form small cells C2, which are placed within the macro cell C1 and which are narrower than the macro cell C1. Also, user terminals 20 are placed in the macro cell C1 and in each small cell C2. For example, a mode may be possible in which the macro cell C1 is used in a licensed band and the small cells C2 are used in unlicensed bands (LTE-U). Also, a mode may be also possible in which part of the small cells is used in a licensed band and the rest of the small cells are used in unlicensed bands.

The user terminals 20 can connect with both the radio base station 11 and the radio base stations 12. The user terminals 20 may use the macro cell C1 and the small cells C2, which use different frequencies, at the same time, by means of CA or DC. For example, it is possible to transmit assist information (for example, the DL signal configuration) related to a radio base station 12 (which is, for example, an LTE-U base station) that uses an unlicensed band, from the radio base station 11 that uses a licensed band to the user terminals 20. Here, a structure may be employed in which, when CA is used between the licensed band and the unlicensed band, one of the radio base stations (for example, the radio base station 11) controls the scheduling of the licensed band cells and the unlicensed band cells.

Note that it is equally possible to use a structure in which a user terminal 20 connects with a radio base station 12, without connecting with the radio base station 11. For example, it is possible to use a structure in which a radio base station 12 that uses an unlicensed band connects with the user terminals 20 in stand-alone. In this case, the radio base station 12 controls the scheduling of unlicensed band cells.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the configuration of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (Home eNodeBs), “RRHs” (Remote Radio Heads), “transmitting/receiving points” and so on. Hereinafter the radio base stations 11 and 12 will be collectively referred to as “radio base stations 10,” unless specified otherwise. Also, it is preferable to configure radio base stations 10 that use the same unlicensed band on a shared basis to be synchronized in time.

The user terminals 20 are terminals to support various communication schemes such as LTE, LTE-A and so on, and may be either mobile communication terminals or stationary communication terminals.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, MIBs (Master Information Blocks) are communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH is frequency-division-multiplexed with the PDSCH and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. The PUSCH may be referred to as an uplink data channel. User data and higher layer control information are communicated by the PUSCH. Also, downlink radio quality information (CQI: Channel Quality Indicator), delivery acknowledgment information (ACKs/NACKs) and so on are communicated by the PUCCH. By means of the PRACH, random access preambles for establishing connections with cells are communicated.

In the radio communication systems 1, cell-specific reference signals (CRSs), channel state information reference signals (CSI-RSs), demodulation reference signal (DMRSs) and so on are communicated as downlink reference signals. Also, in the radio communication system 1, measurement reference signals (SRSs: Sounding Reference Signals), demodulation reference signals (DMRSs) and so on are communicated as uplink reference signals. Note that, the DMRSs may be referred to as user terminal-specific reference signals (UE-specific Reference Signals). Also, the reference signals to be communicated are by no means limited to these.

(Radio Base Station)

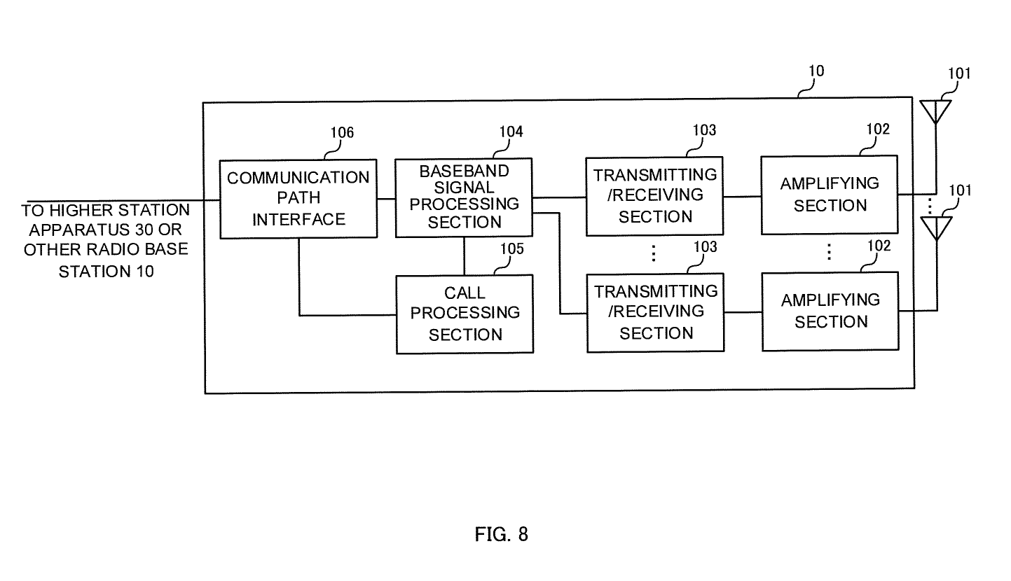

FIG. 8 is a diagram to show an example of an overall structure of a radio base station according to an embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are pre-coded and output from the baseband signal processing section 104 on a per antenna basis are converted into a radio frequency band in the transmitting/receiving sections 103, and then transmitted. The radio frequency signals subjected to frequency conversion in the transmitting/receiving sections 103 are amplified in the amplifying sections 102, and transmitted from the transmitting/receiving antennas 101.

The transmitting/receiving sections 103 are capable of transmitting/receiving UL/DL signals in unlicensed bands. Note that the transmitting/receiving sections 103 may be capable of transmitting/receiving UL/DL signals in licensed bands as well. The transmitting/receiving sections 103 can be constituted by transmitters/receivers, transmitting/receiving circuits or transmitting/receiving devices that can be described based on common understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (for example, an interface in compliance with the CPRI (Common Public Radio Interface)m such as optical fiber, the X2 interface).

Note that the transmitting/receiving sections 103 transmit downlink signals to the user terminal 20 by using at least an unlicensed band. For example, the transmitting/receiving sections 103 transmit a DRS, which includes CSI-RSs that are frequency-multiplexed with the PSS/SSS, to the user terminals 20, in an unlicensed band, in a DMTC duration that is configured in the user terminals 20.

Also, the transmitting/receiving sections 103 receive uplink signals from the user terminals 20 by at least using an unlicensed band. The transmitting/receiving sections 103 may receive DS RRM measurement results (for example, CSI feedback and/or the like), from the user terminals 20, in a licensed band and/or an unlicensed band.

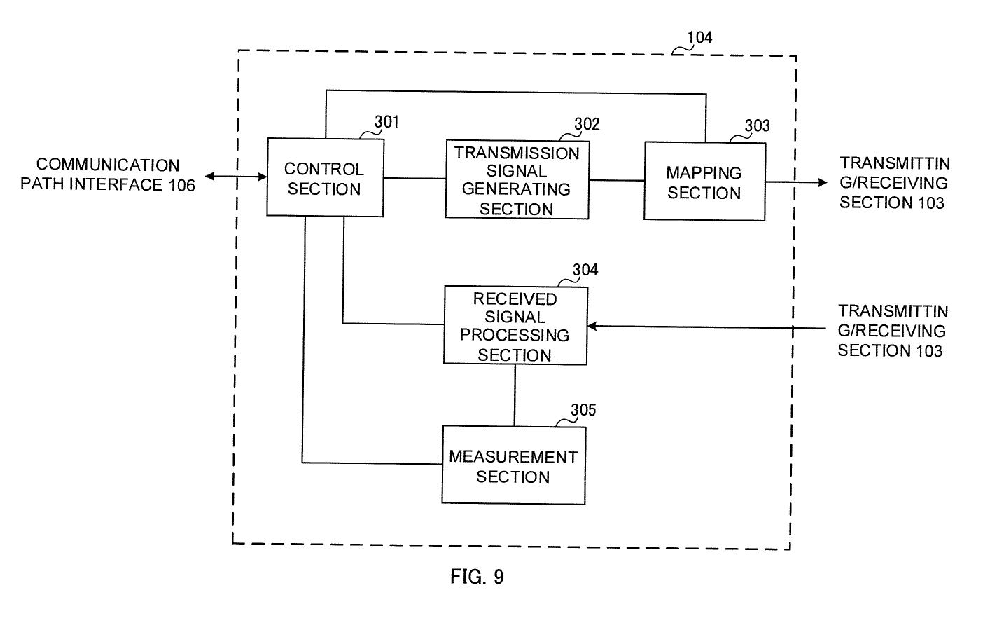

FIG. 9 is a diagram to show an example of a functional structure of a radio base station according to one embodiment of the present invention. Note that, although FIG. 9 primarily shows functional blocks that pertain to characteristic parts of the present embodiment, the radio base station 10 has other functional blocks that are necessary for radio communication as well. As shown in FIG. 9, the baseband signal processing section 104 has a control section (scheduler) 301, a transmission signal generating section (generating section) 302, a mapping section 303, a received signal processing section 304 and a measurement section 305.

The control section (scheduler) 301 controls the whole of the radio base station 10. Note that, when a licensed band and an unlicensed band are scheduled with one control section (scheduler) 301, the control section 301 controls communication in the licensed band cells and the unlicensed band cells. For the control section 301, a controller, a control circuit or a control device that can be described based on common understanding of the technical field to which the present invention pertains can be used.

The control section 301, for example, controls the generation of signals in the transmission signal generating section 302, the allocation of signals by the mapping section 303, and so on. Furthermore, the control section 301 controls the signal receiving processes in the received signal processing section 304, the measurements of signals in the measurement section 305, and so on.

The control section 301 controls the scheduling (for example, resource allocation) of downlink data signals that are transmitted in the PDSCH and downlink control signals that are communicated in the PDCCH and/or the EPDCCH. Also, the control section 301 controls the scheduling of downlink reference signals such as synchronization signals (the PSS (Primary Synchronization Signal) and the SSS (Secondary Synchronization Signal)), the CRS, the CSI-RS, the DM-RS and so on.

Also, the control section 301 controls the scheduling of uplink data signals transmitted in the PUSCH, uplink control signals transmitted in the PUCCH and/or the PUSCH (for example, delivery acknowledgement signals (HARQ-ACKs)), random access preambles transmitted in the PRACH, uplink reference signals and so on.

The control section 301 controls the transmission of downlink signals in the transmission signal generating section 302 and the mapping section 303 in accordance with the results of LBT acquired in the measurement section 305. To be more specific, to control the DRS (LAA DRS) that has been described with the first, the second or the third embodiment to be transmitted in unlicensed bands, the control section 301 controls the generation, mapping, transmission and so on of each signal included in the DRS.

Here, the control section 301 may control the channel state measurement reference signals (CSI-RSs) included in the DRS to be mapped to at least one of the candidate resources of symbols #5 and #6 or symbols #9 and #10 that are defined in an existing CSI-RS configuration. Note that, when the candidate resources of symbols #9 and #10 in an existing CSI-RS configuration are used, the control section 301 can map the CSI-RSs so that the frequency resources match within the PRB.

Also, the control section 301 may control to map at least part of the first synchronization signal (PSS) included in the DRS to the same radio resource as one for the PSS in an existing system, and map at least part of the second synchronization signal (SSS) included in the DRS to the same radio resource as one for the SSS in an existing system.

In addition, the control section 301 may control so that at least part of the first synchronization signal (PSS) and/or the second synchronization signal (SSS) include in the DRS is mapped to six resource blocks other than the six resource blocks where the center frequency of an LBT-executing cell is included. Also, the control section 301 may control predetermined synchronization signals (for example, SSs) and/or reference signals (for example, CRSs) to be mapped to the DRS, in symbols where neither synchronization signal nor reference signals are mapped in the DRS of existing systems.

Furthermore, the control section 301 may control so that the DRS is transmitted in at least one of a plurality of candidate locations provided in a predetermined period (DMTC duration).

The transmission signal generating section 302 generates downlink signals (downlink control signals, downlink data signals, downlink reference signals and so on) based on commands from the control section 301, and outputs these signals to the mapping section 303. The transmission signal generating section 302 can be constituted by a signal generator, a signal generating circuit or a signal generating device that can be described based on common understanding of the technical field to which the present invention pertains.

For example, the transmission signal generating section 302 generates DL assignments, which report downlink signal allocation information, and UL grants, which report uplink signal allocation information, based on commands from the control section 301. Also, the downlink data signals are subjected to the coding process, the modulation process and so on, by using coding rates and modulation schemes that are determined based on, for example, channel state information (CSI) reported from each user terminal. Also, the transmission signal generating section 302 generates a DRS that includes a PSS, an SSS, a CRS, a CSI-RS and so on.

The mapping section 303 maps the downlink signals generated in the transmission signal generating section 302 to predetermined radio resources based on commands from the control section 301, and outputs these to the transmitting/receiving sections 103. The mapping section 303 can be constituted by a mapper, a mapping circuit or a mapping device that can be described based on common understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals and so on). The received signal processing section 304 can be constituted by a signal processor, a signal processing circuit or a signal processing device that can be described based on common understanding of the technical field to which the present invention pertains.

The received signal processing section 304 outputs the decoded information acquired through the receiving processes to the control section 301. For example, when a PUCCH to contain an HARQ-ACK is received, the received signal processing section 304 outputs this HARQ-ACK to the control section 301. Also, the received signal processing section 304 outputs the received signals, the signals after the receiving processes and so on, to the measurement section 305.

The measurement section 305 conducts measurements with respect to the received signals. The measurement section 305 can be constituted by a measurer, a measurement circuit or a measurement device that can be described based on common understanding of the technical field to which the present invention pertains.

The measurement section 305 executes LBT in a carrier where LBT is configured (for example, an unlicensed band) based on commands from the control section 301, and outputs the results of LBT (for example, judgments as to whether the channel state is idle or busy) to the control section 301.

Also, by using the receive signals, the received signal processing section 404 may measure the received power (for example, the RSRP (Reference Signal Received Power)), the received quality (for example, the RSRQ (Reference Signal Received Quality)), channel states and so on. The measurement results may be output to the control section 301.

(User Terminal)

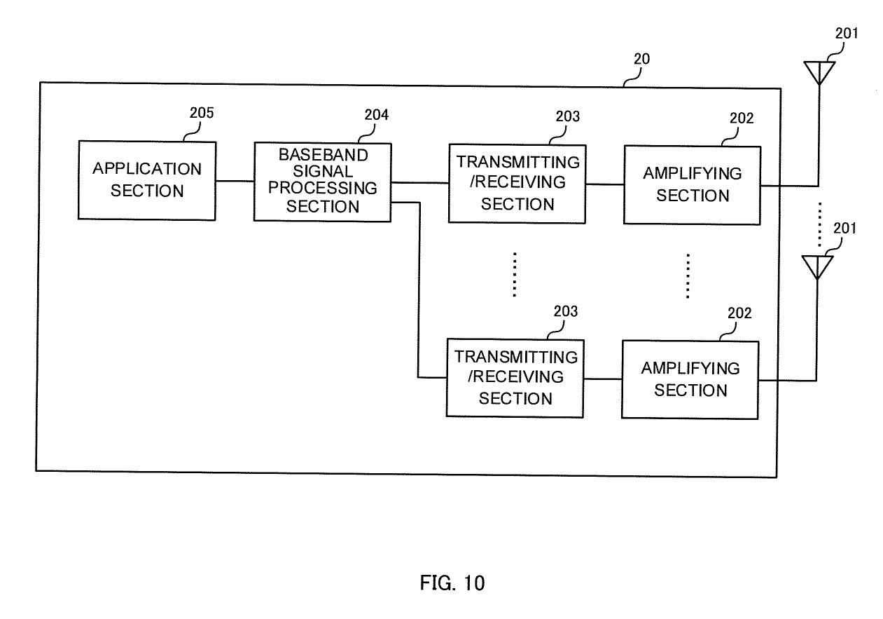

FIG. 10 is a diagram to show an example of an overall structure of a user terminal according to an embodiment of the present invention. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204. The transmitting/receiving sections 203 are capable of transmitting/receiving UL/DL signals in unlicensed bands. Note that the transmitting/receiving sections 203 may be capable of transmitting/receiving UL/DL signals in licensed bands as well.

The transmitting/receiving sections 203 can be constituted by transmitters/receivers, transmitting/receiving circuits or transmitting/receiving devices that can be described based on common understanding of the technical field to which the present invention pertains. Note that a transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 receive downlink signals transmitted from the radio base station 10, by using at least an unlicensed band. For example, the transmitting/receiving sections 203 receive a DRS, which includes CSI-RSs that are frequency-multiplexed with the PSS/SSS, in an unlicensed band, in a DMTC duration that is configured by the radio base station 10.

Also, the transmitting/receiving sections 203 transmit uplink signals to the radio base station 10 by at least using an unlicensed band. For example, the transmitting/receiving sections 203 may transmit DRS RRM measurement results (for example, CSI feedback and/or the like) in a licensed band and/or an unlicensed band.

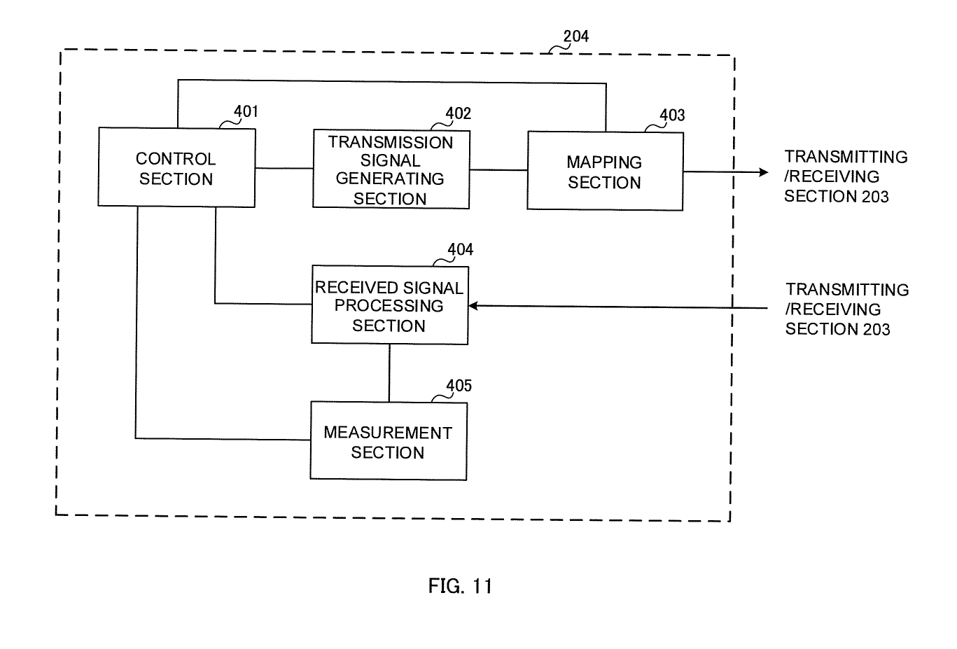

FIG. 11 is a diagram to show an example of a functional structure of a user terminal according to one embodiment of the present invention. Note that, although FIG. 11 primarily shows functional blocks that pertain to characteristic parts of the present embodiment, the user terminal 20 has other functional blocks that are necessary for radio communication as well. As shown in FIG. 11, the baseband signal processing section 204 provided in the user terminal 20 at least has a control section 401, a transmission signal generating section 402, a mapping section 403, a received signal processing section 404 and a measurement section 405.

The control section 401 controls the whole of the user terminal 20. The control section 401 can be constituted by a controller, a control circuit or a control device that can be described based on common understanding of the technical field to which the present invention pertains.

The control section 401, for example, controls the generation of signals in the transmission signal generating section 402, the allocation of signals by the mapping section 403, and so on. Furthermore, the control section 401 controls the signal receiving processes in the received signal processing section 404, the measurements of signals in the measurement section 405, and so on.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on.

The control section 401 may control the received signal processing section 404 and the measurement section 405 to perform RRM measurements and cell search by using DRSs (LAA DRSs) in unlicensed bands. The control section 401 may also control the transmission of uplink signals in the transmission signal generating section 402 and the mapping section 403 in accordance with the results of LBT acquired in the measurement section 405.

To be more specific, the control section 401 may control to receive the DRS that has been described above with the first, the second and or third embodiment. The control section 401 may control to try receiving the DRS in at least one of a plurality of candidate locations that are provided in a predetermined period (DRS occasion). In addition, the control section 401 may control to try receiving the DRS based on at least one of the period (DRS occasion) and the signal configuration (DRS pattern), which are determined based on information about the detection/measurement signal configurations (DRS configurations).

In addition, the control section 401 may control so that, when the PDSCH/EPDCCH are multiplexed with the DRS, the receiving processes are performed by applying rate matching to the PDSCH/EPDCCH.

Also, the control section 401 may control so that the received power, the received quality and/or the channel states, measured in the measurement section 405 by using the reference signals (for example, the CRS, the CSI-RS and so on) included in the LAA DS, are acquired, and, based on these, feedback information (for example, CSI) is generated and transmitted to the radio base station 10.

The transmission signal generating section 402 generates uplink signals (uplink control signals, uplink data signals, uplink reference signals and so on) based on commands from the control section 401, and outputs these signals to the mapping section 403. The transmission signal generating section 402 can be constituted by a signal generator, a signal generating circuit or a signal generating device that can be described based on common understanding of the technical field to which the present invention pertains.

For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal.

The mapping section 403 maps the uplink signals generated in the transmission signal generating section 402 to radio resources based on commands from the control section 401, and output the result to the transmitting/receiving sections 203. The mapping section 403 can be constituted by a mapper, a mapping circuit or a mapping device that can be described based on common understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or a signal processing device that can be described based on common understanding of the technical field to which the present invention pertains. Also, the received signal processing section 404 can constitute the receiving section according to the present invention.

The received signal processing section 404 output the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals, the signals after the receiving processes and so on to the measurement section 405.

The measurement section 405 conducts measurements with respect to the received signals. The measurement section 405 can be constituted by a measurer, a measurement circuit or a measurement device that can be described based on common understanding of the technical field to which the present invention pertains.

The measurement section 405 may execute LBT in a carrier where LBT is configured (for example, an unlicensed band) based on commands from the control section 401. The measurement section 405 may output the results of LBT (for example, judgments as to whether the channel state is idle or busy) to the control section 401.

Also, the measurement section 405 may measure the received power (for example, RSRP), the received quality (for example, RSRQ), the channel states and so on of the received signals. For example, the measurement section 405 performs RRM measurements of the LAA DRS. The measurement results may be output to the control section 401.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. Also, the radio base stations 10 and user terminals 20 may be implemented with a computer device that includes a processor (CPU), a communication interface for connecting with networks, a memory and a computer-readable storage medium that holds programs. That is, radio base stations and user terminals according to an embodiment of the present invention may function as computers that execute the processes of the radio communication method of the present invention.

Here, the processor and the memory are connected with a bus for communicating information. Also, the computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes.

Here, these programs have only to be programs that make a computer execute each operation that has been described with the above embodiments. For example, the control section 401 of the user terminals 20 may be stored in the memory and implemented by a control program that operates on the processor, and other functional blocks may be implemented likewise.

Also, software and commands may be transmitted and received via communication media. For example, when software is transmitted from a website, a server or other remote sources by using wired technologies such as coaxial cables, optical fiber cables, twisted-pair cables and digital subscriber lines (DSL) and/or wireless technologies such as infrared radiation, radio and microwaves, these wired technologies and/or wireless technologies are also included in the definition of communication media.

Note that the terminology used in this description and the terminology that is needed to understand this description may be replaced by other terms that convey the same or similar meanings. For example, “channels” and/or “symbols” may be replaced by “signals” (or “signaling”). Also, “signals” may be “messages.” Furthermore, “component carriers” (CCs) may be referred to as “carrier frequencies,” “cells” and so on.

Also, the information and parameters described in this description may be represented in absolute values or in relative values with respect to a predetermined value, or may be represented in other information formats. For example, radio resources may be specified by indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

The example s/embodiments illustrated in this description may be used individually or in combinations, and the mode of may be switched depending on the implementation. Also, a report of predetermined information (for example, a report to the effect that “X holds”) does not necessarily have to be sent explicitly, and can be sent implicitly (by, for example, not reporting this piece of information).

Reporting of information is by no means limited to the example s/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, MAC (Medium Access Control) signaling, and broadcast information (MIBs (Master Information Blocks) and SIBs (System Information Blocks))), other signals or combinations of these. Also, RRC signaling may be referred to as “RRC messages,” and can be, for example, an RRC connection setup message, RRC connection reconfiguration message, and so on.

The examples/embodiments illustrated in this description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other adequate systems, and/or next-generation systems that are enhanced based on these.

The order of processes, sequences, flowcharts and so on that have been used to describe the example s/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2015-187473, filed on Sep. 24, 2015, including the specification, drawings and abstract, is incorporated herein by reference in its entirety.

1. A user terminal that communicates by using a cell in which listening is executed before signals are transmitted, the user terminal comprising:
a receiving section that receives a detection/measurement signal including a first synchronization signal and a second synchronization signal; and
a measurement section that carries out measurements by using a channel state measurement reference signal, which is included in the detection/measurement signal, and which is frequency-multiplexed with the first synchronization signal and/or the second synchronization signal.

2. The user terminal according to claim 1, wherein, in a predetermined resource block in which the channel state measurement reference signal is frequency-multiplexed with the first synchronization signal and/or the second synchronization signal, the channel state measurement reference signal is mapped to at least one of candidate resources of symbols #5 and #6 or symbols #9 and #10 in an existing channel state information reference signal (CSI-RS) configuration.

3. The user terminal according to claim 1, wherein at least part of the first synchronization signal is mapped to the same radio resource as one for a primary synchronization signal (PSS) in an existing system, and at least part of the second synchronization signal is mapped to the same radio resource as one for a secondary synchronization signal (SSS) in the existing system.

4. The user terminal according to claim 1, wherein part of the first synchronization signal and/or the second synchronization signal is mapped to six resource blocks other than six resource blocks in which the center frequency of the cell is included.

5. The user terminal according to claim 1, wherein the receiving section receives the detection/measurement signal, in which a synchronization signal and/or a reference signal are mapped to symbols in which neither the synchronization signal nor the reference signal is mapped in a discovery signal of an existing system.

6. The user terminal according to claim 1, wherein the receiving section tries to receive the detection/measurement signal in at least one of a plurality of candidate locations provided in a predetermined period.

7. The user terminal according to claim 6, wherein the first synchronization signal and/or the second synchronization signal included in the detection/measurement signal are associated with the candidate locations.

8. The user terminal according to claim 1, wherein the receiving section receives the detection/measurement signal based on at least one of a period and a signal configuration that are determined based on information about a configuration of the detection/measurement signal.

9. A radio base station that communicates with a user terminal by using a cell in which listening is executed before signals are transmitted, the radio base station comprising:
a generation section that generates a detection/measurement signal including a first synchronization signal and a second synchronization signal; and
a transmission section that transmits the detection/measurement signal,
wherein the generating section generates the detection/measurement signal, in which a channel state measurement reference signal that is frequency-multiplexed with the first synchronization signal and/or the second synchronization signal is further included.

10. A radio communication method for a user terminal that communicates by using a cell in which listening is executed before signals are transmitted, the radio communication method comprising the steps of:
receiving a detection/measurement signal including a first synchronization signal and a second synchronization signal; and
carrying out measurements by using a channel state measurement reference signal, which is included in the detection/measurement signal, and which is frequency-multiplexed with the first synchronization signal and/or the second synchronization signal.

11. The user terminal according to claim 2, wherein at least part of the first synchronization signal is mapped to the same radio resource as one for a primary synchronization signal (PSS) in an existing system, and at least part of the second synchronization signal is mapped to the same radio resource as one for a secondary synchronization signal (SSS) in the existing system.

12. The user terminal according to claim 2, wherein part of the first synchronization signal and/or the second synchronization signal is mapped to six resource blocks other than six resource blocks in which the center frequency of the cell is included.

13. The user terminal according to claim 3, wherein part of the first synchronization signal and/or the second synchronization signal is mapped to six resource blocks other than six resource blocks in which the center frequency of the cell is included.

14. The user terminal according to claim 2, wherein the receiving section receives the detection/measurement signal, in which a synchronization signal and/or a reference signal are mapped to symbols in which neither the synchronization signal nor the reference signal is mapped in a discovery signal of an existing system.

15. The user terminal according to claim 3, wherein the receiving section receives the detection/measurement signal, in which a synchronization signal and/or a reference signal are mapped to symbols in which neither the synchronization signal nor the reference signal is mapped in a discovery signal of the existing system.

16. The user terminal according to claim 2, wherein the receiving section tries to receive the detection/measurement signal in at least one of a plurality of candidate locations provided in a predetermined period.

17. The user terminal according to claim 3, wherein the receiving section tries to receive the detection/measurement signal in at least one of a plurality of candidate locations provided in a predetermined period.

18. The user terminal according to claim 2, wherein the receiving section receives the detection/measurement signal based on at least one of a period and the signal configuration that are determined based on information about the configuration of the detection/measurement signal.

19. The user terminal according to claim 6, wherein the receiving section receives the detection/measurement signal based on at least one of the period and the signal configuration that are determined based on information about the configuration of the detection/measurement signal.

20. The user terminal according to claim 7, wherein the receiving section receives the detection/measurement signal based on at least one of the period and the signal configuration that are determined based on information about the configuration of the detection/measurement signal.
